(19) United States
(12) Patent Application Publication
(10) Pub. No.: US 2008/0266833 A1
(43) Pub. Date: Oct. 30, 2008

(54) Illuminated Rigid Body Using Contiguously Illuminated Light Source

(76) Inventor: Jeffery A. Thomas, Huntsville, AL (US)

Correspondence Address: LANIER FORD SHAVER & PAYNE P.C., P O BOX 2087, HUNTSVILLE, AL, 35804-2087, US

(21) Appl. No.: 12/169,280

(22) Filed: Jul. 8, 2008

Related U.S. Application Data
(63) Continuation-in-part of application No. 11/491,865, filed on Jul. 24, 2006, now Pat. No. 7,395,629.
(60) Provisional application No. 60/701,866, filed on Jul. 22, 2005.

(51) Int. Cl. G09G 3/12

(52) U.S. Cl. 362/84

(57) ABSTRACT

A rigid light-passing body is disclosed. Within the body, an electroluminescent strand is supported in a predetermined configuration. In some embodiments, the body may be tubular, with the electroluminescent strand configured in spaced-apart windings around a support extending through the tubular body. In other embodiments related to area lighting, windings or strands may be closely spaced, or touching so that the windings or strands are self-supporting in their predetermined configuration. In other embodiments, there may be multiple strands that produce light of differing colors, the multiple strands attached to a support. The rigid body may also be a spherical shape, with a support therein for supporting at least one electroluminescent strand. For most embodiments, a housing is provided that includes an inverter and battery carrier for providing electrical power to the electroluminescent strand. In other embodiments, electrical power may be provided from an external source.

### CROSS REFERENCE TO RELATED APPLICATIONS

This application is a continuation-in-part application of U.S. patent application Ser. No. 11/491,865, filed Jul. 24, 2006, now U.S. Pat. No. 7,395,629, which is incorporated in its entirety by reference herein, and which claims the benefit of provisional patent application No. 60/701,866, filed Jul. 22, 2005, which is also incorporated in its entirety by reference herein.

### FIELD OF THE INVENTION

This application relates generally to articles or bodies incorporating light sources, and particularly to a rigid, elongated, illuminated body wherein a light source therein is an electroluminescent strand held or supported in a specific, predetermined configuration within the body.

### BACKGROUND IF THE INVENTION

There are many applications in which it would be useful or desirable to have a portable rigid, transparent or translucent elongated body that is illuminated contiguously along its entire length. Such a body may be used for many different purposes, such as handles for doorway entries where the entry is poorly illuminated, as may be found on recreational vehicles, handles for various implements used at night, warning devices for pedestrians and bicycle riders who walk or ride at night, ornamental and novelty items, illumination devices, and many other applications. In addition, military applications include identification devices that produce light of a wavelength that can only be seen using night vision equipment. In most of these applications, it is desirable that the light-producing device be battery powered, and thus consume small amounts of power.

Light emitting diodes (LEDs) have been used for providing small amounts of light, and are well-suited to be powered by batteries. However, LEDs do not produce contiguous, extended light sources wherein light is generated along the length of the light source. In attempting to extend light from LEDs and other point sources of light, such as conventional flashlight bulbs, others have resorted to using light guides, fiber optics and the like. While these work to some extent, light transmission through such a light guide invariably fades as the light guide absorbs some of the light as it passes through the guide. In addition, as efficiency of LEDs has greatly improved in recent years, use of LEDs as light sources has become feasible particularly in flashlight-type devices. However, when used in area lighting applications, the LEDs, being bright point sources of light, tend to produce a great deal of glare.

Electroluminescent wire or rope, and electroluminescent tape, all designated herein as electroluminescent strand, generates uniform light contiguously along its length, and thus is more desirable than a bright point source of light. In addition, electroluminescent strands are very flexible, and can be bent into any configuration. To date, such light sources have been used where flexibility of the light source is needed. For instance, U.S. Pat. No. 6,742,909 discloses a flexible EL line or rope having a braided tension-resisting member surrounding an EL wire extending through the rope. The braided portion provides strength to the rope, and has openings therein through which light may pass. While this structure works as a guide rope, the quantity of light emitted from the EL wire is significantly reduced, and since light is passed through openings in the braided portion, the light is provided as point sources of light. In addition, since the EL wire is used as a core of the rope, the wire is not held in any specific configuration, but is merely strengthened by the braided portion.

A decorative or novelty application of EL wire is disclosed in U.S. Pat. No. 7,073,917, wherein a drinking straw or swizzle stick is provided with a thin transparent tube therewithin that loosely houses a straight, unsupported portion of EL wire, and a base connected by spokes at the end of the straw and between which liquid passes. A battery and inverter for powering the EL wire are mounted in the housing. Being a short length of EL wire, probably on the order of six to eight inches or so, the amount of light produced would only amount to a glow.

In contrast to the above, Applicant proposes a rigid transparent or translucent body wherein a flexible EL strand is supported in a selected or predetermined configuration that provides more light than a single EL strand by itself. The EL light strand may extend from one end of the elongated body to another component of the body, or may extend from the elongated body at any point between ends of the body to such other component.

### BRIEF DESCRIPTION OF THE DRAWINGS

FIG. 1 is an illustration showing an illuminated body of the instant invention.

FIG. 2 is a sectional view taken along lines 2-2 of FIG. 1.

FIG. 3 is a view of another embodiment of the invention.

FIG. 3a is a sectional view taken along lines 3a-3a of FIG. 3.

FIG. 3b is a sectional view taken along lines 3b-3b of FIG. 3.

FIG. 4 is a cut-away view showing construction details of the invention.

FIG. 5 is a view of another embodiment of the invention.

FIG. 6 shows construction details of one embodiment of the invention.

FIG. 7 illustrates a cut-away view of a spherical embodiment of the invention.

FIG. 8 illustrates another spherical embodiment of the invention.

### DETAILED DESCRIPTION OF THE DRAWINGS

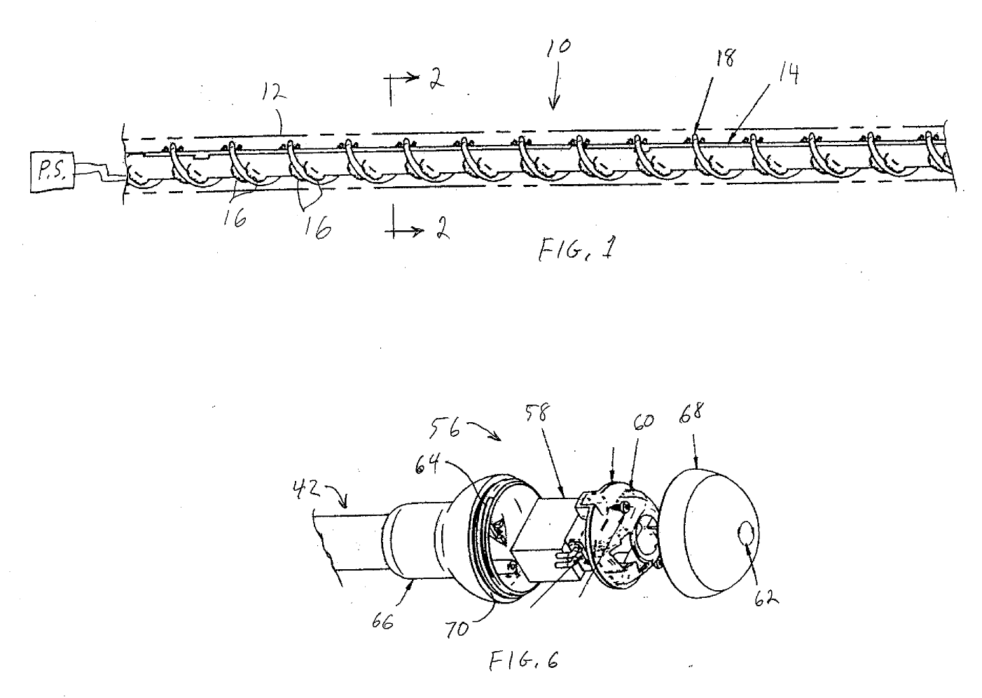

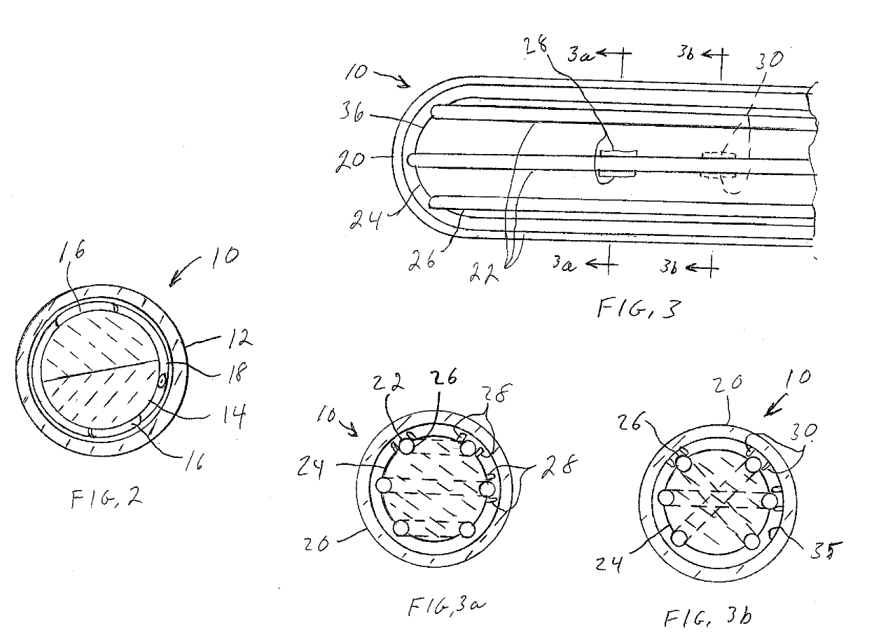

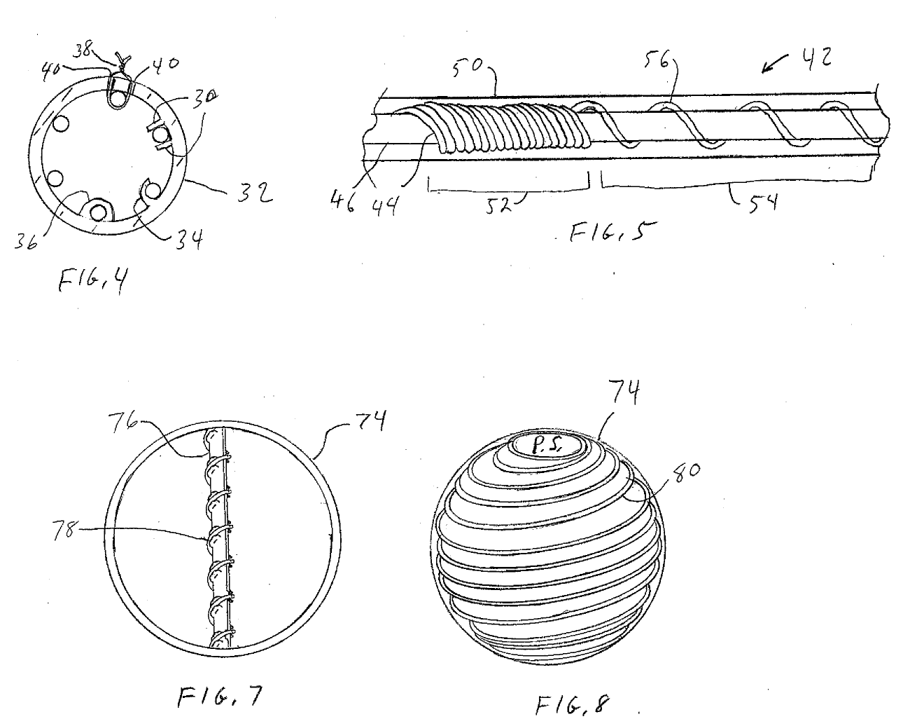

Referring initially to FIGS. 1 and 2, a rigid, light-transmissive body 10 is shown. Here, a body or housing 10 is constructed having a transparent or translucent outer tubular portion 12 of a rigid material, such as polycarbonate, acrylic, fiberglass or the like. A central support 14 may be provided, and also may be constructed of a transparent or translucent, rigid material such as polycarbonate, acrylic, fiberglass or the like. Alternately, central support 14 may be of a stronger material, such as aluminum or other suitable metal, which metal being in some instances suitable for receiving a reflective plating for reflecting light, or of an opaque plastic or wood. Central support 14 may also be a load-bearing member of a structure, such as a column for holding up a portion of a building, or a load-bearing member for a portable article such as a walking cane or walking stick. Central support 14 may be provided with one or more attachments to support a flexible length of electroluminescent (EL) strand in a selected or predetermined configuration, and may comprise a series of pairs of ridges 16 that are spaced so as to snugly receive the electroluminescent (EL) strand or strand 18. In the embodiment shown in FIG. 1, EL strand 18 is wound around central support 14 in a spiral configuration and snugly fitted into ridges 16 so that each winding or turn of EL strand 18 is held in place by three pairs of ridges 16. In addition, as shown in FIG. 2, a diameter of support 14 may be such that ridges 16 are in close proximity to an inner wall of tubular portion 12 so that when support 14 is placed or mounted within tubular portion 12 with EL strand wound around support 14 and held in place by ridges 16, a distance between ridges 16 and the inner wall of tubular portion 12 is smaller than a diameter of EL strand 18, assuring that the EL strand cannot slip out of place from its predetermined configuration. Other attachments may be used in conjunction with a central support 14, as shown and described with respect to FIG. 4. With this construction, many turns of EL strand, and thus a much longer length of EL strand than a length of tubular body portion 12, may be incorporated into tubular body portion 12. As such, light from the EL strand of a predetermined configuration is concentrated so that such light is much brighter or more intense than would otherwise be the case from a single strand of EL strand.

In another embodiment of the instant invention, and referring to FIG. 3, one end of a tubular outer portion 20 is shown as being closed, with EL strand 22 disposed longitudinally therein and mounted to or otherwise fixed to a central support 24 that may be a rigid rod or of rigid rod-like construction. EL strand 22 may be fitted into grooves 26 molded or cut into support 24, and held in place by pairs of ridges 28 attached to central support 24 (FIG. 3a) similar to ridges 16 shown in FIG. 1. Alternately, pairs of ridges 30 (dashed lines) may be incorporated along inner walls 35 of tubular outer portion 20. As with the embodiment of FIG. 1, a spacing between the ridges and inner walls of tubular outer portion 20 may be such that there is insufficient room for the EL strand to slip out of place from its selected configuration.

In another embodiment, tubular outer portion 20 may itself be configured to hold the EL strand in a selected, predetermined configuration. In this embodiment, the central support may be omitted. Here, and as shown in FIG. 4, different ways of holding the EL strand in place without a central support are shown. Here, the EL strand is held in place by various attachments against or closely proximate an inner wall of tubular body 32. One such attachment, as noted above, may include ridges 30 that frictionally engage an EL strand and hold it in place within a tubular body 32 where body 32 is constructed sufficiently rigid and sufficiently durable to serve its intended purpose, such as a handle, support, part of a novelty item, an illumination device or any other suitable application. Other attachments for holding the EL strand in place to the inner wall of tubular member 32 include hook-shaped protrusions 34 that frictionally engage and clamp the EL strand in place. In addition, tubular portion 32 may be extruded along with the EL strand so that the EL strand is permanently embedded in, molded or sealed or otherwise associated within at least portions of at least one enlarged region 36 of tubular body 32. Such enlarged regions 36 need not extend contiguously the length of tubular member or body 32. Here, such enlarged regions 36 may be molded into tube 32, and the EL strand threaded through the enlarged regions. Such enlarged regions 36 may extend the length of tube 32, or may be smaller segments, for example ¼ to ½ inch or so in length. In yet another embodiment, a tie 38, such as a wire tie or zip tie may be used in conjunction with small openings 40 in tubular member 32 to attach the EL strand in place. In yet another embodiment, tubular body 32 may be cast or extruded as a solid, rigid member with loops or portions of EL strand cast or extruded in place within tubular portion 32, similar to EL strand and enlarged portion 36, except the entire tubular portion would be solid. In yet another embodiment, the EL strand may be cast or extruded in the central support 14 itself.

In some embodiments, such as shown in FIG. 3 and by dashed lines in FIG. 3a, EL strand 26 may be looped over an end 36 of central support 24 as shown so that the loops do not intersect one another. In one embodiment, the loops may be separate from one another and may be separately powered so that if one loop fails, the other loops would still be illuminated. Where body 10 is part of a novelty device, each of the loops may be a separate length of EL strand and of a different color, and selectively switchable so that different combinations of loops may be illuminated, producing different colors. These different combinations would produce different combinations of light, such as where red, green and blue light was produced from respective loops, an overall white light would be developed. Where red and blue light was produced from respective loops, an overall purple light would be produced. As there are at least 9 different colors of EL strand currently available, where a body 10 contains loops of EL strand of each of the 9 different colors, there would be hundreds of different combinations of loops that would produce hundreds of different colors of light. Of course, a lesser number of loops each producing a different color, or the same color, may also be used.

In yet another embodiment, instead of using loops of EL strand, a shorter segment may be held in position along the length of central support 14 or along an inside wall of tubular portion 32. In this embodiment, many such lengths of different colors could be included in a single tubular body 10. In addition, such multiple segments of EL strand of different colors may be configured and a spiral as shown in FIG. 1 or 5 so that a color of light developed by each winding of EL strand is different from light produced by adjacent windings of EL strand.

Electrically illuminating selected ones of a number of loops or lengths of EL strand could be accomplished digitally by generating a binary code for each combination of EL strands, thus producing different effects and different colors of light. For instance, where there are 4 strands each of a different color in a novelty or lighting device, a 4 bit binary code would provide up to 15 different combinations of the strands and produce 15 different colors. Either a “0” or “1” could be used to illuminate a respective EL strand via a buffer amplifier in turn powering an AC inverter or pulse generator. All that would be necessary would be to provide a binary code generator of sufficient bandwidth so as to accommodate the number of EL strand lengths so that all possible combinations of colors may be provided. The colors may be accessed by making the binary code sequential, and responsive to pushing a button so that repeatedly pushing the button cycles through the binary code and thus the colors. Such a scheme would suffice where there were a small number of differently colored EL strand strands, such as 3 or 4, so that only 8 or 16 bits would be needed, respectively, to fully cycle through all possible combinations of lengths of EL strand to generally produce a respective number of colors.

In the embodiment of FIG. 3b, the same EL strand may be looped several times within portion 20. Here, a groove 26 at ends of support 24 may be deeper so as to allow intersecting and overlapping portions of the EL strand to fit thereinto. In this instance the length of EL strand may all be the same color, although it would be possible to splice different colors into the same length of EL strand.

In yet another embodiment, and as shown in FIG. 5, a body 42 for an illumination wand or device may be constructed simply by winding EL strand 44 in very closely spaced, or touching, relation about a central support 46 within a transparent or translucent tubular member 50, as shown by the portion enclosed by bracket 52. In this instance, the device would effectively illuminate a small area, such as the interior of a tent or the like. This embodiment is advantageous in that with area lamps that use a point source of light, such as one or more LEDs, glare is produced from the point source of light (the LEDs themselves) that can make using such a lamp difficult. With an illumination device of the instant invention, a more diffuse light is produced over a much larger area, thus such glare is eliminated. As described for FIG. 4, such closely-spaced or touching windings may also be affixed to an interior of tubular portion 32 in order to fabricate an illumination device, and using any of the schemes to attach the windings to inner walls of member 32. In addition, where windings of EL strand are closely wound into a rigid, transparent tube and the windings extend generally the length of the tube, such as the windings as shown in FIG. 5 for an illumination device, such windings may be self-supporting due to the windings bearing against and supporting each other, thus eliminating a need to be fixed to either a central support or the interior walls of a transparent tubular member. Further, rather than using windings, lengths of EL strand as shown in FIG. 3 may be closely packed together and supported by either a central support or along interior walls of a transparent tubular member in order to fabricate an illumination device. While the loops of EL strand and central support of FIG. 3 are shown extending to near an end of rigid tube 20, it should be apparent that the loops of EL strand need only generally extend the length of tubular member 20, as a portion of tubular member 20 may also form a handle, battery compartment or other component of the article.

In a baton or other device, and as also shown in FIG. 5, a region of closely spaced or touching windings of EL strand, as indicated by bracket 52, may be disposed at one or both ends of the baton. When thrown, these regions 52 that generate more concentrated areas of light would produce striking effects. A central portion of the baton as indicated by brackets 54 may, but not necessarily, have less tightly-packed windings 56 of EL strand so that the central portion of the baton would also be illuminated although to a lesser degree. In the instance of a baton having closely spaced windings of EL strand at each ends thereof, a bulbous portion 56 (FIG. 5, shown as an exploded view) may be attached to each end of the baton containing the EL strand, portion 56 housing an inverter 58, a battery carrier 60, and may incorporate a diaphragm that when pressed operates a switch to provide electrical power from batteries in battery carrier 60 to power the device. Threads 64 on a base 66 of bulbous portion 56 engage corresponding threads (not shown) in cap 68 so that cap 68 may be secured in place, and an O-ring seal 70 may be provided between base 66 and cap 68 to waterproof the base/cap connection. Alternately, one end may contain a single power supply and inverter that powers EL strand in both ends of the baton, with the other end provided with a weight for balancing the baton. Of course, such a power supply could be incorporated into any device including a body of the instant invention, or a device including the body of the instant invention, such as a door handle, may be powered by an external power supply that is not battery-powered.

FIGS. 7 and 8 illustrate rigid members that are not tubular, but rather are spherical. FIG. 7 shows a cut-away rigid spherical housing 74 that encloses and supports a support 76, as by fixing support 76 to inner walls of housing 74. Support 76 may be configured as any of the supports described herein, and may extend generally centrally within spherical member 74. An EL strand 78 may be supported by any of the described attachments, including embedding the strand within support 76. The EL strand 78 may be battery powered by batteries and an inverter (not shown) within a compartment, which may be waterproof, within spherical housing 74. In addition, multiple EL strands, each producing a different color and toward as described about may be configured as windings around support 76. Also, multiple supports 76 traversing the interior of spherical housing 74 in different directions may be incorporated, each with EL strand windings, within spherical housing 74.

FIG. 8 also shows a spherical housing 74, except windings 80 of the EL strand are supported near or against an inner surface of spherical housing 74. In this embodiment, the windings may be supported by any of the described attachments, or by other attachments such as bonding the EL strand to interior walls of spherical housing 74. In addition, an interior support may be used as described above. Such support may also be an inflatable support that presses the windings of EL strand against interior walls of spherical housing 74. A battery power supply and inverter, designated PS, may be incorporated at one end of the EL strand 80. As described above, alternate windings producing different colors may be used in these spherical embodiments, which windings may be energized in different combinations to produce different colors.

From the foregoing, it should be apparent that EL strands may be supported in a predetermined configuration within any rigid transparent or translucent member of any shape to create novel area lighting or other articles.

Having thus described my invention and the manner of its use, it should be apparent to those skilled in the relevant arts that incidental changes may be made to my invention that fairly fall within the scope of the following appended claims, wherein I claim:

1. An illuminated body comprising:
a rigid member of a character so as to pass light from within,
at least one length of flexible electroluminescent strand that generates light contiguously along its length,
said flexible electroluminescent strand configured in a predetermined configuration and supported within said rigid member in said predetermined configuration.

2. An illuminated body as set forth in claim 1 wherein said rigid member is a tubular member.

3. An illuminated body as set forth in claim 1 wherein said rigid member is a spherical member.

4. An illuminated body as set forth in claim 1 wherein said rigid member is a solid member.

5. An illuminated body as set forth in claim 2 wherein said electroluminescent strand is supported in said predetermined configuration by attachments on an inner wall of said rigid member.

6. An illuminated body as set forth in claim 5 wherein said attachments further comprise pairs or sets of ridges for frictionally engaging said electroluminescent strand, holding said electroluminescent strand in said predetermined configuration.

7. An illuminated body as set forth in claim 5 wherein said attachments further comprise hook-shaped protrusions for frictionally engaging and holding said EL strand in said predetermined configuration.

8. An illuminated body as set forth in claim 5 wherein said attachments further comprises incorporating said electroluminescent strand within at least portions of said rigid member.

9. An illuminated body as set forth in claim 5 wherein said attachments further comprise one or more ties for tying said electroluminescent strand in said predetermined configuration to an interior of said rigid member.

10. An illuminated body as set forth in claim 2 wherein said electroluminescent strand is supported by attachments on a support within said rigid member.

11. An illuminated body as set forth in claim 10 wherein said support is a rigid support.

12. An illuminated body as set forth in claim 1 wherein said predetermined configuration comprises windings of said electroluminescent strand in a spiral configuration.

13. An illuminated body as set forth in claim 12 wherein said windings are spaced apart.

14. An illuminated body as set forth in claim 12 wherein said windings are very closely spaced or in contact with each other.

15. An illuminated body as set forth in claim 12 wherein said windings are in contact with each other, and are self-supporting by bearing against and supporting each other, said windings extending the length of said rigid member.

16. An illuminated body as set forth in claim 1 wherein said predetermined configuration further comprises at least one loop of EL strand looped at least once so that said at least one loop of EL strand is supported within said rigid member and forms two lengths of EL strand within said rigid member.

17. An illuminated body as set forth in claim 16 further comprising a plurality of loops of EL strand, each of said loops producing light of a different color.

18. An illuminated body as set forth in claim 16 wherein said at least one loop of EL strand is a single strand looped lengthwise in said rigid member.

19. An illuminated body as set forth in claim 1 further comprising a plurality of separate lengths of said electroluminescent strand, each of said separate lengths of said electroluminescent strand supported within said rigid member in said predetermined configuration and each of said separate lengths of said electroluminescent strand producing light of a different color.
